(19) United States
(12) Patent Application Publication
(10) Pub. No.: US 2009/0289045 A1
(43) Pub. Date: Nov. 26, 2009

(54) FOOTWELL HEATING EQUIPMENT

(76) Inventor: James Hotary, Holland, MI (US)

Correspondence Address: BARNES & THORNBURG LLP, 11 SOUTH MERIDIAN, INDIANAPOLIS, IN, 46204, US

(21) Appl. No.: 12/125,695

(22) Filed: May 22, 2008

(51) Int. Cl. B60L 1/02

(52) U.S. Cl. 219/202

(57) ABSTRACT

Footwell heating equipment is provided to heat a footwell provided in a vehicle. The footwell heating equipment includes a heating element and a heater control system coupled to the heating element.

### BACKGROUND

The present disclosure relates to automobile footwell heating equipment. More particularly, the present disclosure relates to such equipment configured to cooperate with vehicle occupant (e.g., driver and/or passenger) climate control and seat heating systems.

### SUMMARY

Automobile footwell heating equipment in accordance with the present disclosure includes a footwell heating element assembly that operates in conjunction with an automobile's environmental and seat heating systems.

In illustrative embodiments, the heating element assembly may include radiant heat members provided in the footwell walls, footwell floor or floor mats, and/or a front facing portion of an automobile seat. Alternatively, or in addition, the heating element assembly may include a vent configuration including a heating element and being provided on a front facing portion of an automobile seat. Additionally, footwell heating equipment provided in a middle or rear seat of an automobile may also include a heating element assembly that includes a radiant heat member or a vent configuration provided in a rear facing portion of a seat in front of the footwell.

In illustrative embodiments, the footwell heating equipment may be optionally operated along with environmental heating systems for the automobile. Alternatively, the footwell heating equipment may be optionally operated along with a seat heating system that is specific to or associated with the footwell in which the equipment is located.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective side view of a vehicle incorporating seats with heating element assemblies in the driver and passenger side seats for providing radiant heat to driver and passenger side footwells;

FIG. 2 is a side perspective view of the driver and front passenger seats in a vehicle, wherein each of the illustrated seats include a heating element assembly in front facing side of the lateral portion of the seats and each of the heating element assemblies is operationally controlled by individual controls located in a central console between the seats;

FIG. 3 is a side perspective view of a mid-section or rear section of a vehicle wherein heating element assemblies are provided on a back side of a vertical portion of a front set of seats and also on front facing sides of the lateral portion of the back seats such that passengers sitting in the back seats are provided with radiant heat from two sides of the their respective footwells;

FIG. 4 is a side perspective view of a driver seat illustrating additional detail of one design of the beating element assembly located in the front facing side of the lateral portion of the seat, wherein the heating element assembly includes both a heating element comprised of far IR emitting fabric and a cover fabric comprised of seat fabric provided to protect the far IR emitting fabric;

FIG. 5 is a top pan view of a vehicle incorporating seats with heating element assemblies in the driver and passenger side seats for providing radiant heat to driver and passenger side floor heat zones including driver and passenger footwells and controlled by respective heat zone controllers which may be included as part of a driver or passenger's zone climate control controller or may be a separate controller;

FIG. 6 is a functional block diagram illustrating a relationship between an individual's climate control system and associated controllers and power source for a heating element assembly;

FIG. 7 is an alternative functional block diagram illustrating a relationship between an individual's seat heater and associated controllers and power source for a heating element assembly;

FIG. 8 is another alternative functional block diagram illustrating a relationship between a vehicle's environmental or climate control system and associated equipment including controllers and a power source for heating element assemblies;

FIG. 9 is a perspective side view of a vehicle incorporating seats with a heating element assembly provided in the front facing side of the lateral portion of the driver seat and a heating element assembly provided in the driver footwell floor matt for providing radiant heat to driver footwell;

FIG. 10 is a front perspective view of a driver seat illustrating additional detail of one design of the heating element assembly located in the front facing side of the lateral portion of the seat, wherein the heating element assembly includes both a vent configuration and a heating element; and

FIG. 11 is a side perspective view of a mid-section or rear section of a vehicle wherein heating element assemblies are provided on a back side of a vertical portion of a front set of seats and also on front facing sides of the lateral portion of the back seats and heating element assemblies are provided in the footwell floor matts such that passengers sitting in the back seats are provided with radiant heat from the front, rear and floor sides of the their respective footwells.

### DETAILED DESCRIPTION

Automobile footwell heating equipment in accordance with the present disclosure includes one or more footwell heating element assemblies that are operative in conjunction with an automobile's environmental and/or seat heating systems. Such heating element assemblies may be placed in various positions surrounding or included in an automobile vehicle footwell, for example, within or on the vertical or substantially vertical walls surrounding a footwell, included in a front-facing portion of the lateral portion of an automobile seat, on the lower portion of the rear-facing side of a vehicle seat (to provide frontal heating of a footwell for a middle or rear seat of an automobile, in a footwell floor, or in removable footwell floor mats, etc.

In illustrative embodiments, a heating element assembly may include one or more radiant heat members provided in the footwell walls, footwell floor or floor mats, and/or a front facing portion of an automobile seat.

A perspective side view of an automobile vehicle 100 incorporating seats 110, 120 including heating element assemblies 105, 115, and 125 is provided in FIG. 1. More specifically, a driver seat 110 includes a heating element assembly 105 provided in or on the front-facing portion of the seat's lateral support. Likewise, heating element assemblies 115 are provided in or on the front-facing portion of the seat's lateral support for passenger seats 120. Additionally, for the footwells associated with the middle and rear passenger seats 120, heating element assemblies 125 may be provided in the lower portion of the rear facing side of the seat proximately in front of the footwell.

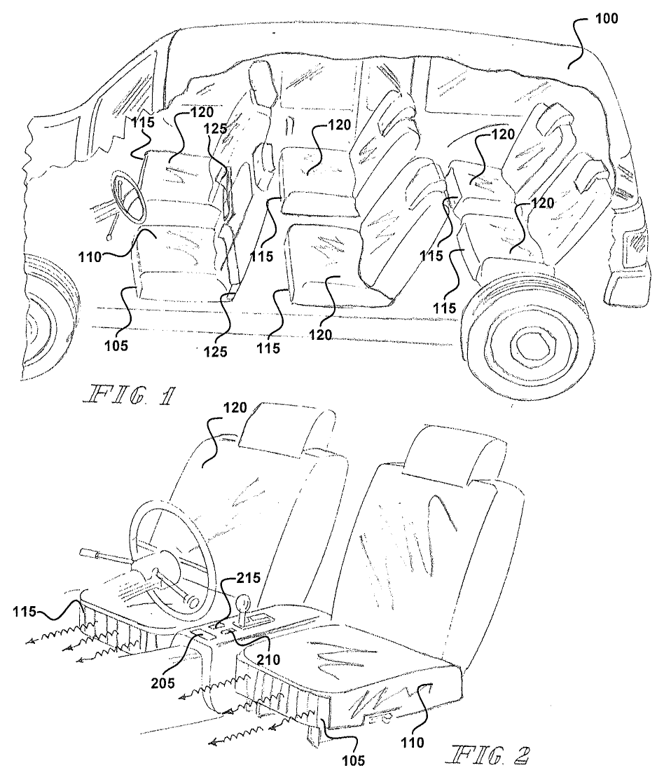

As illustrated in FIG. 2, both the driver seat 110 and front passenger seat 120 in vehicle 100 may include a heating element assembly 105, 115 in the front-facing side of the lateral portion of the seats. When operated, these heating element assemblies 105, 115 may provide radiant or radiating heat to the footwell associated with the seats 110, 120. Each of the heating element assemblies 105, 115 may be operationally controlled by individual controls 210, 215 located in a central console between the seats 110, 120. Alternately, the operation of the heating element assemblies 105, 115 may be controlled by a master control 205, for example, to trigger operation of the heating element assemblies 105, 115 when seat heaters included in each of the seats 110, 120 are operated.

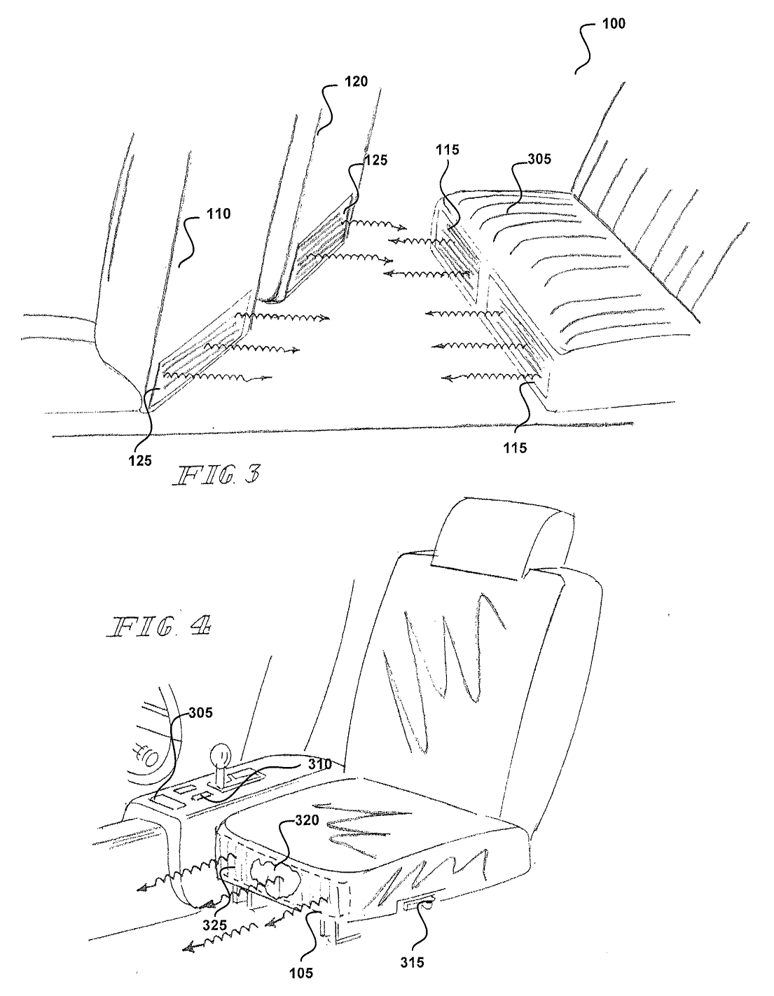

Additional footwell heating equipment may be provided in a middle or rear seat of an automobile, for example, providing a heating element assembly in a rear-facing portion of a seat in front of the footwell. A side perspective view of a mid-section or rear section of a vehicle 100 is provided in FIG. 3 wherein heating element assemblies 125 are provided on the back sides of vertical portion of the front set of seats 110, 120. Additionally, heating element assemblies 115 may also be provided on the front-facing sides of the lateral portion of the back seat 305 (in this example, a bench seat) such that passengers sitting in the back seats 120 are provided with radiant or radiated heat from two sides of the their respective footwells.

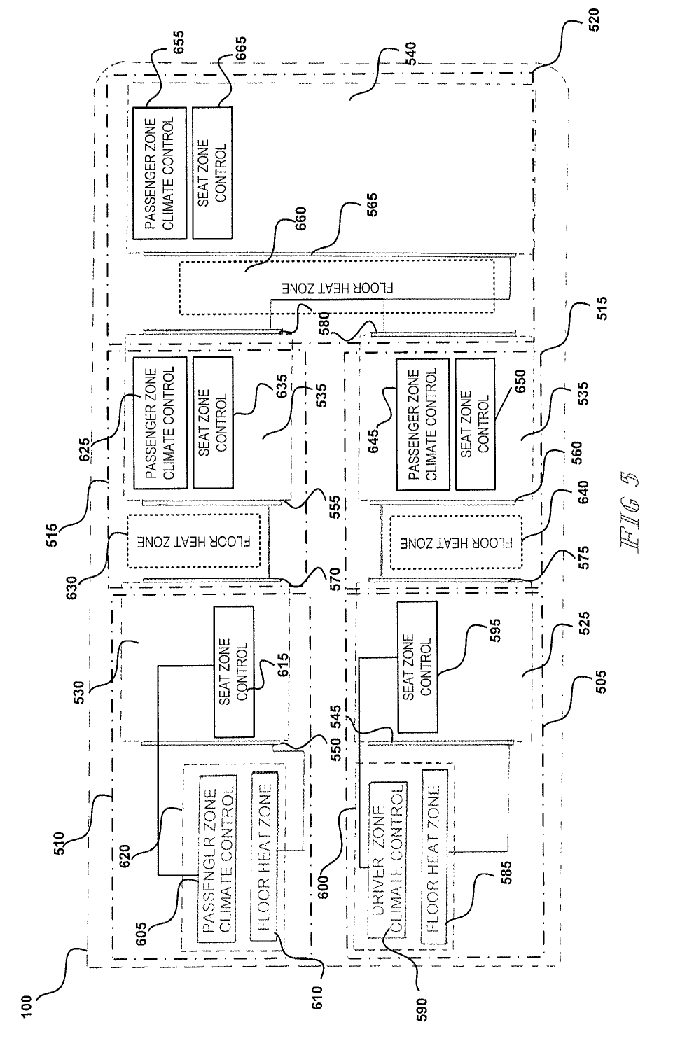

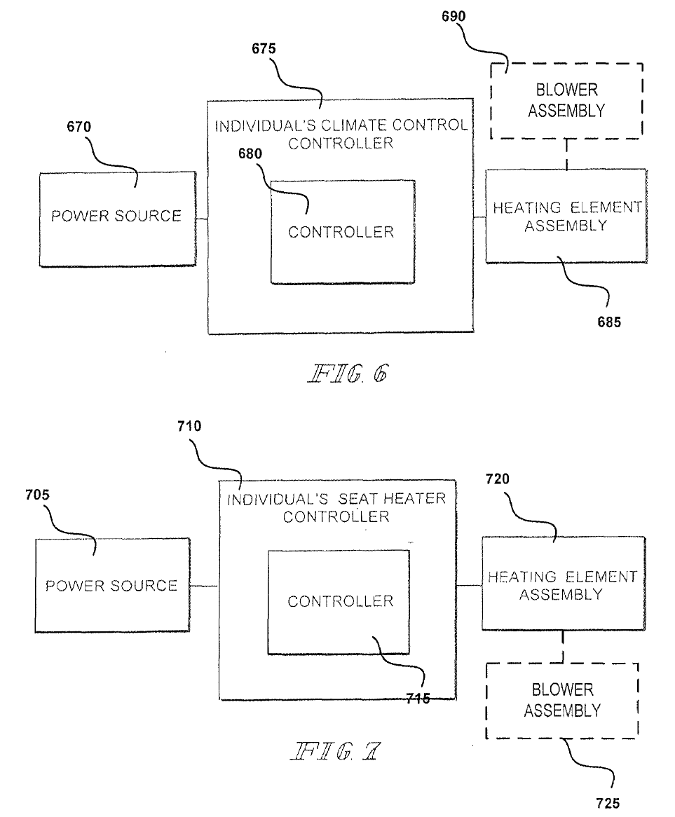

A side perspective view of a driver seat is provided in FIG. 4. This illustrates additional detail of one design of the heating element assembly 105 located in the front facing side of the lateral portion of the seat 110.

The heating element 105 may include, for example, a heat-emitting material 320 and a cover fabric 325 comprised of seat fabric provided to protect the heat-emitting material 320. For example, the heating-mitting material 320 may be a far Infrared Radiation (IR) emitting material. Various types of IR radiating material are available commercially, for example, various products are manufactured by Easy Heating GMBH (located in Friedburg, Germany) including Vario, VArio Plus, Premium S and Premium M heating fabrics. Such fabrics, and other like them, provide flexible, heating fabric that is base isolated and may require between 12-42 volts for low voltage operation or higher voltage for other types of operation. Such fabrics may be constructed of, for example, glass silk with woven Carbon, which function as heaters to provide heat. In implementation, a voltage feed for such fabric may be provided using woven, silver alloyed copper threads. The material may be implemented as a laminate including a multilayer system that has a hard cover with extremely high warmth stability.

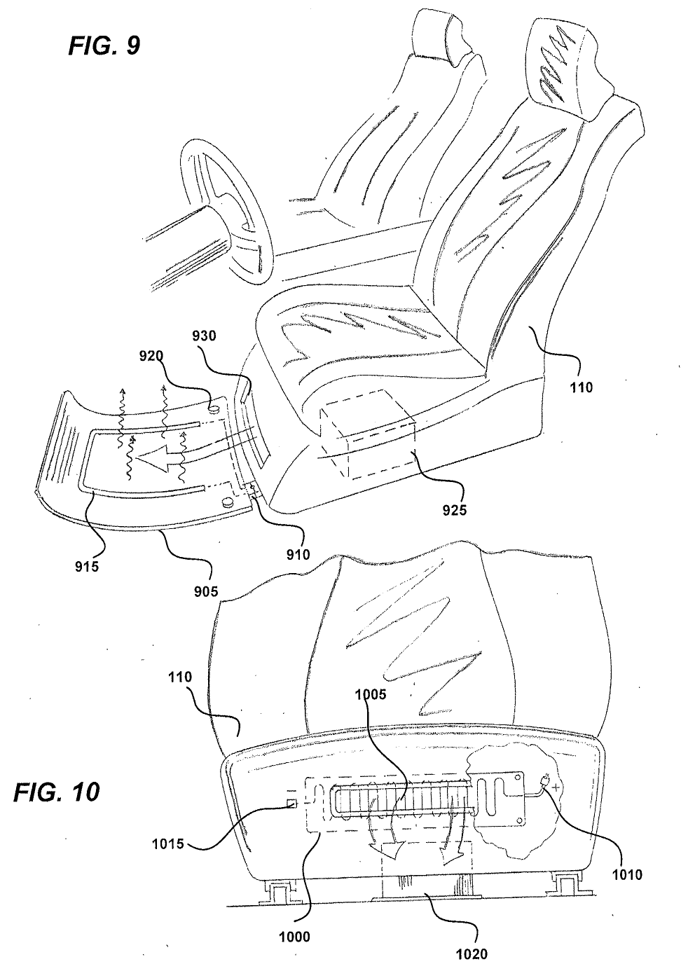

In the illustrated embodiment of FIG. 4, the heating element assembly 105 may be controlled by one or more control switches 305, 310, 315 provided in different locations proximate to the seat 110. Thus, a control switch 305 may provide, for example, cooperation for the heating element assembly 105 with the driver's personalized climate control systems (not shown in FIG. 4) and/or a driver seat heater (not shown), e.g., automatic operation of the heating element assembly 105 when the driver seat heater is operated. Alternatively, or in addition, the operation of the heating element assembly or the degree of heating (or in connection with the embodiment of FIG. 9, a degree of ventilation).

Thus, in illustrated embodiments, the footwell heating equipment may be optionally operated along with a seat heating system that is specific to or associated with the footwell in which the equipment is located.

Moreover, as illustrated in FIG. 5, an automotive vehicle 100 may incorporate seats associated with individual zones including one or more heating element assemblies providing heating to the footwells associated with those zones. As shown in FIG. 5, the driver seat 525, front passenger seat 530, mid-interior individual seats 535 and rear bench seat 540 may each be associated with its own respective climate control, seat control, and floor heat control. For example, the driver seat 525 is included in the driver seat zone 505, whereas the front passenger seat 530 is included within the front passenger zone 510. Likewise, the mid-interior individual seats 535 are each included in respective mid-interior individual seat zones 515 and the rear bench seat 540 is included in the rear bench seat zone 520.

Within each of these zones, one or more heating element assemblies may be provided to generate and radiate heat to a footwell included in the zone. For example, within the driver seat zone 505 is included a heating element assembly 545 (illustrated for example on the front-facing lateral portion of the front passenger seat 525). Likewise, within the front passenger zone 510 is included a heating element assembly 550 (illustrated for example on the front-facing lateral portion of the front passenger seat 530).

Within the mid-interior individual seat zones 515 may include more than one heating element assembly, e.g., 555, 560 provided on the front-facing lateral portions of the mid-interior individual passenger seats 535 as well as 570, 575 provided on the rear-facing lateral portions of the driver and front passenger seats 525, 530. In this way, passengers in the mid-interior individual seats 535 may be provided with heat from two directions (e.g., front and rear).

Similarly, passengers sitting on the rear-bench seat 540 may have a footwell(s) heated by rear-facing heating element assemblies 580 provided in the mid-interior individual seats 535 as well as a front-facing heating element assembly 565 that may, optionally span a majority of the length of the bench seat 540 so as to provide heating to multiple (e.g., more than two) passengers sitting on the bench seat 540.

Each seat zone may include various controllers for heating the zone. For example, the driver seat zone 505 may include a floor-heat zone controller 585, a driver-zone climate controller 590, and a seat-zone controller 595 each for controlling, respectively the floor heat (provided by heating element assembly 545), driver climate control (provided via a climate control system not illustrated in FIG. 5), and seat heat (provided via a driver seat heater not illustrated in FIG. 5). Moreover, it should be appreciated that, optionally, the floor-heat zone controller 585 may be coupled with the driver-zone climate controller 590 in a single controller unit 600. Further, although not illustrated in FIG. 5, the floor-heat zone controller 585 and the seat zone controller 595 may be optionally provided in a single controller unit.

Similarly, the passenger seat zone 510 may include a floor-heat zone controller 610, a passenger zone climate controller 605, and a seat zone controller 615 each for controlling, respectively the floor heat (provided by heating element assembly 550), passenger climate control (provided via a climate control system not illustrated in FIG. 5), and seat heat (provided via a passenger seat heater not illustrated in FIG. 5). Moreover, it should be appreciated that, optionally, the floor heat zone controller 610 may be coupled with the passenger zone climate controller 605 in a single controller unit 620. Further, although not illustrated in FIG. 5, the floor heat zone controller 610 and the seat zone controller 615 may be optionally provided in a single controller unit.

Further, with regard to the mid-interior individual passenger seats, the passenger seat zones 515 may each include floor-heat zone controllers 630, 640, passenger zone climate controller 625, 645, and seat zone controller 635, 650 each for controlling, respectively the floor heat (provided by heating element assembly 555, 570 and 560, 575), passenger climate control (provided via a climate control system not illustrated in FIG. 5), and seat heat (provided via a passenger seat heater not illustrated in FIG. 5). Moreover, it should be appreciated that, optionally, the floor-heat zone controller 630, 640 may be coupled with the passenger zone climate controller 625, 645 in single controller units. Further, although not illustrated in FIG. 5, the floor heat zone controllers 630, 640 and the seat zone controllers 635, 650 may be optionally provided in a single controller unit.

The passenger seat zone 520 may include a floor-heat zone controller 660, a passenger-zone climate controller 655, and a seat zone controller 665, each for controlling, respectively the floor heat (provided by heating element assemblies 565, 580), passenger climate control (provided via a climate control system not illustrated in FIG. 5), and seat heat (provided via a passenger seat heater not illustrated in FIG. 5). Moreover, it should be appreciated that, optionally, the floor-heat zone controller 660 may be coupled with the passenger-zone climate controller 655 in a single controller unit. Further, although not illustrated in FIG. 5, the floor-heat zone controller 660 and the seat zone controller 665 may he optionally provided in a single controller unit.

Thus, in illustrative embodiments, the footwell heating equipment may be optionally operated along with or in conjunction with environmental heating systems for the vehicle. For example, as illustrated in FIG. 6, the heating element assembly controller 680 may be incorporated in or operate in combination with an individual's climate control controller 675. FIG. 6 is a functional block diagram illustrating a relationship between the individual's environmental or climate control and associated controllers and power source for the heating element assembly and associated optional equipment. Accordingly, the individual's climate control controller and/or heating element assembly(s) controller 680 may be coupled to a power source 670 and also to the heating element assembly(s) 685. Further, in conjunction with embodiments illustrated in FIGS. 9-11, the controller 680 and heating element assembly may be coupled to a blower assembly 690 (explained in detail herein with reference to FIGS. 9-11) that may or may not be part of the heating element assembly(s) 685.

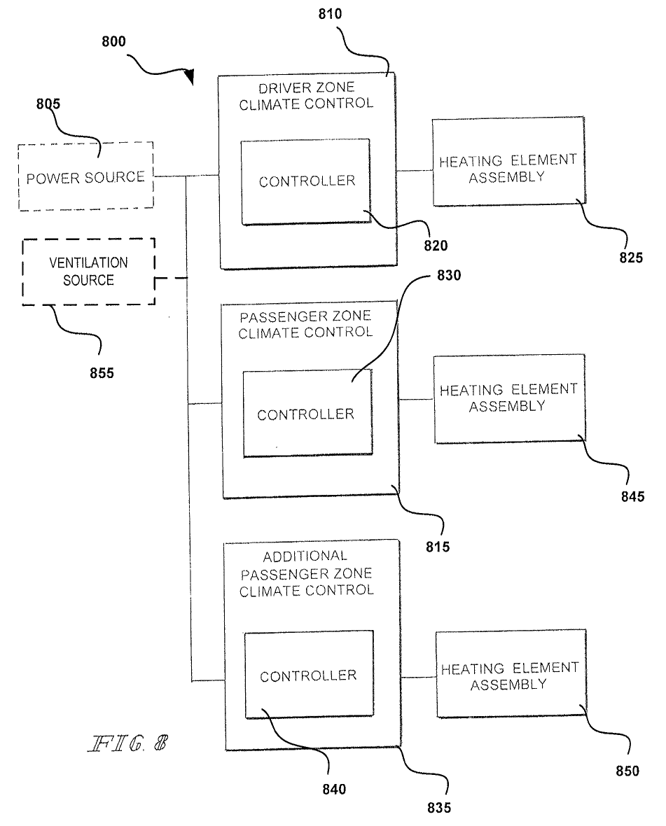

Further, as illustrated in FIG. 7, the heating element assembly controller 715 may be incorporated in or operate in combination with an individual's seat-heater controller 710 (as illustrated also in FIG. 4). FIG. 7 is illustrates a relationship between an individual's seat heater and associated controllers and power source for a heating element assembly.

Accordingly, the individual's seat-heater controller 710 and/or heating element assembly(s) controller 715 may be coupled to a power source 705 and also to the heating element assembly(s) 720. Further, in conjunction with embodiments illustrated in FIGS. 9-11, the controller 715 and heating element assembly may be coupled to a blower assembly 725 (explained in detail herein with reference to FIGS. 9-11) that may or may not be part of the heating element assembly(s) 720.

FIG. 8 illustrates a relationship between an automobile vehicle's environmental or climate control system 800 and associated equipment including controllers and a power source for heating element assemblies. As illustrated in FIG. 8, a power source 805 (for example, the combination of the vehicle's battery and alternator, now shown) may be coupled to the various controllers associated with particular zones of the vehicle, e.g., driver zone and one or more passenger zones. Such controllers include the driver-zone climate controller 810, and one or more passenger-zone climate controllers 815, 835. In at least one illustrated embodiment, the zone climate controllers 810, 815, 835 may include or cooperate with the heating element assembly(s) controllers 820, 830, 840, respectively. Further, those controllers 820, 830, 840 may control operation of their corresponding heating element assemblies 825, 845 and 850. The controllers and power source 805 are also optionally coupled to a ventilation source 855 that may be implemented as a conventionally known heating/air conditioning system or as a purpose-specific ventilation source, e.g., in connection with the illustrated embodiments of FIGS. 9-11.

As mentioned above, in at least some illustrative embodiments, a heating element assembly may include or work in cooperation with a vent configuration and/or blower assembly. In such an implementation, a heating element may be provided on a front or rear facing portion of an automobile seat and air may be forced through the heating element so as to provide heated air circulation in the footwell area of a driver and/or passengers. Such illustrated embodiments will now be described with reference to FIGS. 9-11.

FIG. 9 is a perspective side view of a vehicle including a driver seat 110 including a heating element assembly 930 provided in the front facing side of the lateral portion of the driver seat 110. As explained in more detail in connection with FIG. 10, the heating element assembly 930 may include a heat element placed in a ventilation opening. A blower assembly 925 is provided, for example, under a lateral portion of the driver seat 110 and operates to force air through the ventilation opening, passing the heat element so as to generate heated air in the footwell area.

FIG. 9 also illustrates an embodiment wherein a heating element assembly 915 is provided in the driver footwell floor matt 905 for providing radiant heat to driver footwell. The driver footwell floor matt 905 is couplable to the vehicle floor via connections 920 so that the driver footwell floor matt 905 remains in place. Unlike conventionally known heated floor matts, the heating element assembly 915 included in the floor matt 905 is powered via connection 910 with the vehicle's electric system. As a result, it should be appreciated that operation of the heating element assembly 905 may be controlled by operation of driver seat heating elements or the driver seat climate controller. This is significantly different than conventionally available heated floor matts that are powered via plug into a vehicle's cigarette lighter.

Returning to the illustrated embodiment wherein the heating element assembly includes a heat element in combination with a means for ventilation, FIG. 10 illustrates a front perspective view of a driver seat 110 and illustrating additional detail of one design of the heating element assembly located in the front facing side of the lateral portion of the seat, wherein the heating element assembly includes both a vent configuration 1000 and a heating element 1005. As illustrated, air flowing through the vent configuration 1000 is heated by proximity with the heating element 1005. The heating element may be, for example, electric wiring that is designed as a grid or serpentine pattern enabling air to pass through the wiring and thereby be heated as the wiring raises in temperature as a result of the application of a current through the wiring through contacts 1010, 1015. Although not illustrated, it should be appreciated that the heating element assembly in the embodiment illustrated in FIG. 10 may also include a vent cover that helps to ensure safe operation of the assembly given the elevated temperature of the heating element 1005.

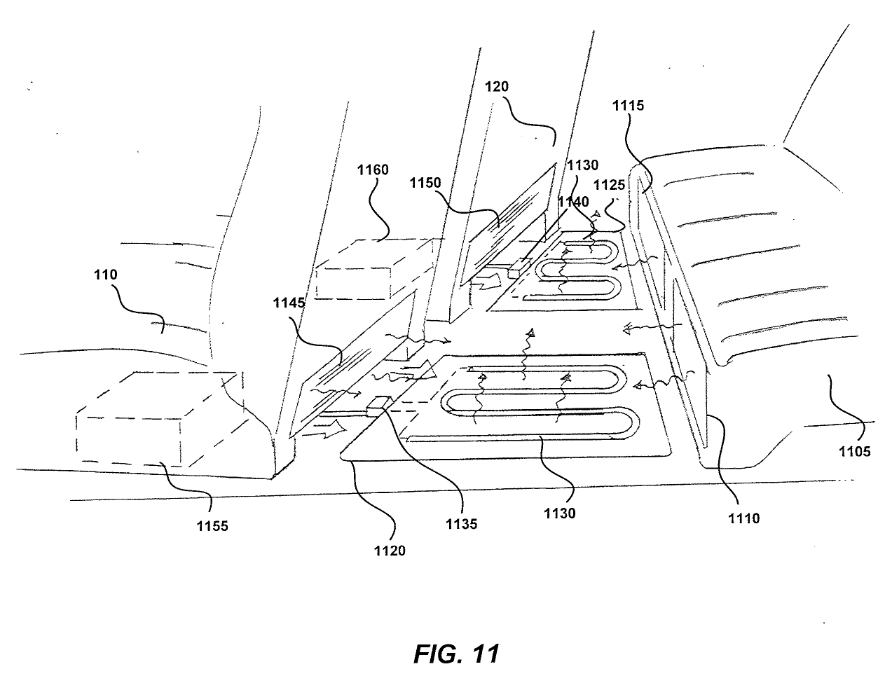

Footwell heating equipment provided in a mid-interior seat or rear seat of an automobile may also include a heating element assembly such as that illustrated in FIGS. 10 and 11. As a result, the equipment may include a vent configuration provided in a rear facing portion of a seat in front of the footwell. For example, FIG. 11 is a side perspective view of a mid-section or rear section of a vehicle wherein the rear seat 1105 includes heating element assemblies 1110, 1115 in the front facing portion of the lateral section of the rear seat 1105 (illustrated here, by example only, as a bench seat) as well as heating element assemblies 1145, 1150 being provided on a back side of a vertical portion of a front set of seats 110, 120.

As shown in FIG. 11, the ventilation for heating element assemblies 1145, 1150 may be provided via the blower assemblies 1155, 1160 respectively.

In addition, FIG. 11 illustrates further heating element assemblies 1130 included in the footwell floor matts 1120, 112 powered via connections 1135, 1140 (optionally in combination with the seat heating controls for the rear seat 1105). As a result of this combination of heating element assemblies, passengers sitting in the back seat 1105 may be provided with radiant heat from the front, rear and floor sides of the their respective footwells.

It should be appreciated that, although not specifically illustrated, the heating element assemblies may be powered as part of a pre-driving conditioning operation for an automobile. In such an operation, one or more of the heating element assemblies (e.g., those associated with the driver seat) may be powered prior to the driver entering the automobile so as to improve the comfort level of the driver upon entry. Such conditioning operations may be implemented as part of vehicle-wide pre-driving conditioning operation; for example, when a driver is able to remotely start a vehicle so as to warm up the engine and, potentially, the vehicle interior. Alternatively, or in addition, such conditioning operations may be implemented in conjunction with and powered by electric-assisted pre-conditioning of automobiles, e.g., where a vehicle may be, for example, in a particularly cold environment and/or may be an electrically powered or hybrid vehicle.

Although the present disclosure has been described and illustrated in detail, it is to be clearly understood that this is done by way of illustration and example only and is not to be taken by way of limitation. The scope of the present disclosure is to be limited only by the terms of the appended claims.

Therefore, for example, although the disclosure refers to automobile vehicles, it should be appreciated that utility of the illustrated embodiments is not limited to automobiles but may apply to any vehicle or craft wherein one or more footwells are included.

1. Vehicle footwell heating equipment comprising
a footwell heating element assembly located in a vehicle footwell, the footwell heating element assembly including at least one heating element, and
means for controlling the footwell heating element assembly, the means for controlling being coupled to the footwell heating element assembly,
wherein the means for controlling the footwell heating element assembly is coupled to and cooperates with a vehicle occupant climate control controller so as to provide heat to the vehicle footwell in cooperation with the vehicle's climate control or seat heating systems.

2. The footwell heating equipment of claim 1, wherein the footwell heating element assembly includes at least one radiant heat member provided in a front-facing portion of a vehicle seat corresponding to the vehicle footwell.

3. The footwell heating equipment of claim 1, wherein the footwell heating element assembly includes at least one radiant heat member provided in at least one wall of the vehicle footwell.

4. The footwell heating equipment of claim 1, wherein the footwell heating element assembly includes at least one radiant heat member provided in the floor of the vehicle footwell.

5. The footwell heating equipment of claim 1, wherein the footwell heating element includes a heat-emitting material and a cover fabric comprised of seat fabric provided to protect the heat-emitting material.

6. The footwell heating equipment of claim 5, wherein the heat-emitting material is a far Infrared Radiation (IR) emitting material.

7. The footwell heating equipment of claim 1, wherein the footwell heating element assembly includes at least one radiant heat member provided in a floor mat of the vehicle footwell.

8. The footwell heating equipment of claim 1, wherein the footwell heating element assembly includes a vent configuration including a heating element past which air is ventilated so as to provide heated air to the footwell.

9. The footwell heating equipment of claim 8, wherein the footwell heating element assembly is provided in front-facing portion of a vehicle seat.

10. The footwell heating equipment of claim 1, wherein the footwell heating element assembly is provided in a front-facing portion of a vehicle seat corresponding to the footwell and wherein the footwell heating equipment further comprises an additional footwell heating element assembly provided in a rear-facing portion of a vehicle seat in front of the footwell.

11. The footwell heating equipment of claim 1, wherein the footwell heating element assembly controller optionally controls operation of the footwell heating element assembly automatically when a heater for a vehicle seat corresponding to the footwell is operated.

12. The footwell heating equipment of claim 1, wherein the footwell heating element assembly controller optionally controls operation of the footwell heating element assembly automatically when a vehicle occupant climate control system is operated to heat an area associated with a vehicle seat associated with the footwell.

13. The footwell heating equipment of claim 1, wherein the footwell heating element assembly controller includes at least one user-operated control switch that controls operation of the footwell heating element assembly.

14. The footwell heating equipment of claim 13, wherein the at least one user-operated control switch controls a degree of heating provided by the footwell heating element assembly or degree of ventilation provided by the footwell heating element assembly.

15. The footwell heating equipment of claim 1, wherein the footwell heating element assembly may be operated as part of a pre-driving conditioning operation for a vehicle.

16. The footwell heating equipment of claim 15, wherein the footwell heating element assembly is provided for a footwell associated with a driver seat of the vehicle.

17. The footwell heating equipment of claim 15, wherein operation of the footwell heating element assembly may be initiated remotely from the vehicle.

18. The footwell heating equipment of claim 15, wherein operation of the footwell heating element assembly is performed as part of an electric-assisted pre-conditioning of the vehicle, where the vehicle can be coupled to a stationary electricity source when not being driven.

19. An integrated vehicle occupant heating system comprising
an occupant-specific climate control system,
an occupant seat heater,
a footwell heating element assembly located in a vehicle footwell associated with the occupant seat including the passenger seat heater, the footwell heating element assembly including at least one heating element, and
means for controlling and coordinating operation of the occupant-specific climate control system, the occupant seat heater, and the footwell heating element assembly.

20. An integrated vehicle occupant heating system comprising
a occupant seat heater,
a footwell heating element assembly located in a vehicle footwell associated with the passenger seat including the occupant seat heater, the footwell heating element assembly including at least one heating element, and
a controller configured to coordinate operation of the occupant seat heater and the footwell heating element assembly.
